(19) United States
(12) Patent Application Publication
(10) Pub. No.: US 2023/0259786 A1
(43) Pub. Date: Aug. 17, 2023

(54) OBFUSCATION OF ENCODED DATA WITH LIMITED SUPERVISION

(71) Applicant: Protopia AI, Inc., Austin, TX (US)

(72) Inventors: Hadi Esmaeilzadeh, Austin, TX (US); Kurtis Evan David, Austin, TX (US)

(21) Appl. No.: 18/170,476

(22) Filed: Feb. 16, 2023

Related U.S. Application Data
(60) Provisional application No. 63/311,014, filed on Feb. 16, 2022.
(60) Provisional application No. 63/420,287, filed on Oct. 28, 2022.

(51) Int. Cl. G06N 3/088

(52) U.S. Cl. CPC G06N 3/088

(57) ABSTRACT

Provided are unsupervised mechanisms for generating obfuscation of data for machine learning applications.

### CROSS-REFERENCE TO RELATED APPLICATIONS

This application claims the benefit of U.S. Provisional Pat. App. 63/311,014, titled QUASI-SYNTHETIC DATA GENERATION FOR MACHINE LEARNING MODELS, filed 16 Feb. 2022, and claims the benefit of U.S. Provisional Pat. App. 63/420,287, titled SELF-SUPERVISED DATA OBFUSCATION, filed 28 Oct. 2022, the entire content of each of which is hereby incorporated by reference.

### BACKGROUND

Machine learning models including neural networks have become the backbone of intelligent services and smart devices. To operate, the machine learning models may process input data from data sources, like cameras, microphones, unstructured text, and output classifications, predictions, control signals, and the like.

Generally, the machine learning models are trained on training data. Training data may itself be sensitive in some cases. For example, training data may be expensive to generate and serve as a valuable trade secret. Further, training data may contain information burdened with confidentiality or privacy obligations, including information that an entity is legally obligated to protect from disclosure to third parties.

### SUMMARY

The following is a non-exhaustive listing of some aspects of the present techniques. These and other aspects are described in the following disclosure.

Some aspects include application of a stochastic layer in a machine learning model and/or autoencoder.

Some aspects include a tangible, non-transitory, machine-readable medium storing instructions that when executed by a data processing apparatus cause the data processing apparatus to perform operations including the above-mentioned application.

Some aspects include a system, including: one or more processors; and memory storing instructions that when executed by the processors cause the processors to effectuate operations of the above-mentioned application.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 depicts an example machine learning model trained using an obfuscated dataset, in accordance with some embodiments;

FIG. 2A depicts a system for encoding a representation of data, in accordance with some embodiments;

FIG. 2B depicts a system for applying noise to an encoded representation of data, in accordance with some embodiments;

FIG. 3 depicts a system for obfuscation of sensitive attributes while applying noise to an encoded representation of data, in accordance with some embodiments;

FIG. 4 illustrates an exemplary method for data obfuscation with limited supervision, according to some embodiments;

FIG. 5 shows an example computing system that uses a stochastic noise layer in a machine learning model, in accordance with some embodiments;

FIG. 6 shows an example machine-learning model that may use one or more vulnerability stochastic layer; and

FIG. 7 shows an example computing system that may be used in accordance with some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the fields of machine learning and computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some approaches to obfuscating data require that a trained model be available when configuring the obfuscation process. However, in some cases, that trained model is not available, e.g., when data is being offered to third parties that will not share their models, when the model has not yet been created, or when the model architecture is expected to change in ways that are difficult to predict. The issue is particularly acute for training data, which generally exists independently from the models for which it is to be used for training.

To mitigate these issues or others, some embodiments obfuscate training data in a way that leaves the obfuscated training data suitable for training a machine learning model but conceals the un-obfuscated version of the training data. Some embodiments train a model that obfuscates training data, referred to herein as an obfuscator. To train the obfuscator, some embodiments obtain training data, train an autoencoder on the training data, and learn parameters of parametric noise distributions of inserted noise layers (e.g., upstream of the decoder, such as after the latent representation is formed). The parametric noise distributions may be learned with the techniques described in U.S. patent application Ser. No. 17/458,165, filed 26 Aug. 2021, titled METHODS OF PROVIDING DATA PRIVACY FOR NEURAL NETWORK BASED INFERENCE, the contents of which are hereby incorporated by reference, with the decoder or other downstream part of the autoencoder serving the role of the machine learning model into which obfuscated data is input in the reference. The trained obfuscator may then ingest records of the training data and output obfuscated versions of those records, e.g., from intermediate stages of the autoencoder augmented with the inserted noise layers, such as by pruning the decoder and outputting obfuscated data from a noise layer downstream of the latent representation.

Obfuscated records may be obfuscated in two senses. First, the intermediate stages of the autoencoder may transform the input data into a form from which the input data cannot be re-created, such as by lower-dimensional intermediate layers that implement, in effect, a lossy compression of input data. Second, the noise layers may inject noise by randomly sampling from learned parametric noise distributions (e.g., for each dimension of the respective layer) corresponding to each dimension of the intermediate layer's intermediate representation of the input (e.g., latent representation) and combining the sampled noise with the respective dimension's value, e.g., by adding, subtracting, dividing, multiplying, or other combinations that maintain differentiability of the objective function used to learn the parametric noise distributions, in some embodiments. In some embodiments, the obfuscator may be trained without having access to the model the obfuscated training data is to be used to train.

Some embodiments quantify a maximum (e.g., approximation or exact local or global maximum) perturbation to a training data set for generation of an obfuscated training data set input to a model's training process that will allow the model to be correctly trained successfully (e.g., satisfying a threshold metric for model performance) on the obfuscated training data set. Some embodiments afford a technical solution to training data obfuscation formulated as a gradient based optimization of parametric noise distributions (e.g., using a differentiable objective function (like a loss or fitness function), which is expected to render many use cases computationally feasible that might otherwise not be) implemented, in some cases, as a loss function over a pre-trained autoencoder. The outcome of training the obfuscator may be a loss expressed as a maximum perturbation that causes a minimum loss across a machine learning model, which may be an autoencoder. The loss may be determined to find a maximum noise value that may be added (or otherwise combined, like with subtraction, multiplication, division, etc.) at one or more layer of the machine learning model to produce an obfuscated training data set that may be used to train a subsequent machine learning model. Some embodiments may produce obfuscated training data that may be applied to train various machine learning models, such as neural networks operating on image data, audio data, or text for natural language processing.

Some embodiments measure training data sets susceptibility to noise addition. To this end, some embodiments determine a maximum perturbation that may not cause mis-training of a machine learning model. In some embodiments, a tensor of random samples from a normal distribution (or one or more other distributions e.g., Gaussian, Laplace, binomial, or multinomial distributions) may be added to (or otherwise combined with) the input tensor X to determine a maximum variance value to the loss function of the neural network or autoencoder.

Machine learning algorithms consume data during training and, after training (or during active training), at runtime, generally without sample data being processed in the latter category. Training data may include sensitive data that parties would like to keep confidential for various reasons. For instance, in many federated learning use cases, an untrained or partially trained model may be distributed to other computing devices with access to data to be used for training, and then in some cases, those distributed machines may report back the updates to the model parameters (or simply execute the trained model locally on novel data without reporting model parameters back). In some cases, during training, the model is on a different network, computing device, virtual address space, or protection ring of an operating system relative to a data source. This may increase the attack surface for those seeking access to such data and lead to the exposure of the data, which may reveal proprietary information or lead to privacy violations. A single compromised computing device could expose the data upon which that computing device trains the model. Similar issues may arise in applications training a model on a single computing device. Training data may be exposed to attach or capture during transfer and across various machines where it is used for training, including updating, active learning, batch training, etc.

To mitigate these or other issues, some embodiments obfuscate training data. The transformed, or obfuscated, data set may have two characteristics: (1) sensitive data may be obfuscated and (2) sufficiently accurate machine learning models may be trained using the transformed or obfuscated data set. In some cases, the amount of noise and dimensionality of intermediate layers of the autoencoder may be tuned according to tradeoffs between obfuscation and accuracy, with greater dimensionality and lower noise being expected to afford greater accuracy and reduced obfuscation, and vice versa. The transformed or obfuscated data set may then be used as training data for a model, where the training data does not disclose sensitive information if disclosed to an adversary. In some cases, the un-obfuscated training data is not accessible to the model (e.g., from the process training the model), which may also be trained in a distributed method or using other security measures. In some embodiments, a maximum noise or stochastic layer parameters are determined for which a minimum perturbation to model training is expected. The maximum noise may be determined based on a loss function in some cases.

In some embodiments, the training data set, herein also referred to as dataset D, may be decomposed. The dataset D may contain multiple records, each with features X and, in some cases, like in supervised learning use cases, labels Yⱼ. The labels Yⱼ may be one or more downstream labels. The dataset D may be any appropriate dataset, such as tabular data, images, audio files, formatted or unformatted natural language or structured text, etc. The transformation of the dataset D into the obfuscated training data, herein also referred to as dataset D′, may be performed independent of the model (e.g., machine learning model) that is to be trained based on the dataset D and which is thereby replaced in training by the dataset D′.

Some embodiments determine a maximum noise independent of the machine learning model. In some embodiments, the transformation is applied to the dataset D independently of Y (e.g., independently of any labels or downstream labels). In some embodiments, the transformation may include removal of Y (e.g., removal of labels), such that a model trained on the dataset D may be trained in an unsupervised manner. The obfuscator performing the transformation may be characterized as an unsupervised machine learning model. In order to determine a maximum noise that may be applied to the dataset D using gradient descent (such as stochastic gradient descent or other gradient based optimization) or another appropriate method, an autoencoder may be trained on the dataset D. Various autoencoders may be used, including transformer architectures. The autoencoder may not be the machine learning model to be trained with the obfuscated data (e.g., the machine learning model that is to be trained on the training data/dataset D to generate accurate output). The autoencoder may be independent of (e.g., trained in the absence of) the machine learning model to be trained on obfuscated data and may be used to generate obfuscated training data for training various heterogenous machine learning models or for other applications.

In some embodiments, the autoencoder may include two models in a pipeline, an encoder and a decoder, and in some cases, dimensionality of intermediate layers may be different from inputs and outputs of the autoencoder, e.g., with a bottleneck layer between the two that has lower dimensionality than the input or output. The autoencoder may be a neural network. The encoder may be a model or a portion of a model that reduces the dimensionality of the elements (or other records) of the dataset D, or alternatively, the dimensionality of the elements may be increased or maintained. The encoder may produce a latent representations of the elements of the dataset D, e.g., inputting a record with a first dimensionality may produce a latent representation with different dimensionality. The latent representations may be the representations of the elements of the dataset D at the bottleneck layer. The encoder may operate on individual elements of the dataset D, e.g., produce obfuscated data elements one at a time, or may operate on a batch of elements of the dataset D at once. In some embodiments, the decoder may be a model or portion of a model that increases the dimensionality of a latent representation output by the encoder, or, alternatively, the dimensionality of the elements may be reduced or maintained. The decoder may likewise operate on individual elements or batches of elements of the dataset D. The decoder may take as input the output of the encoder. The autoencoder may include a bottleneck layer, which may be a connection between the encoder and decoder. In some embodiments, the encoder may implement a form of lossy compression of inputs. A difference between the output of the autoencoder and the input of the autoencoder may be determined and minimized during training, such as by using reconstruction loss measurement. In some embodiments, the autoencoder may be trained with a differentiable objective function using gradient descent. The autoencoder may be trained based on reconstruction loss minimization.

Once the autoencoder is trained, the output of the encoder may be used to generate obfuscated training data, e.g., the dataset D′. In some embodiments, the output of the encoder may be used to generate the dataset D′.

In some embodiments, further obfuscation is provided by learning a set of noise distributions that, when applied to intermediate representations of data, still yield acceptable accuracy of the trained decoder or a trained model (e.g., trained on the obfuscated data). A noise layer (also referred to as a stochastic noise layer) may be applied to the encoded representations of the elements of the dataset D in order to generate the dataset D′. The noise layer may be applied to one or more encoded representations of the data, such as the latent representation, a representation at the bottleneck layer, a hidden layer representation layer, etc. One or more stochastic noise layer may be used. A stochastic noise layer may be used to apply noise to the latent representations of the elements of the dataset D at the bottleneck layer. The noise layer may include parametric noise distributions, which may be normal distributions, binomial distributions, multinomial distributions, Gaussian distributions, etc. of noise. The noise layer may include noise values and/or a noise distribution for each component or each dimension of the representation of the elements of the dataset D at the layer where the stochastic noise is applied, or for a subset. For example, the noise layer may apply a value sampled from a noise distribution to each component of the latent representation at the bottleneck layer. Thus, inputting the same value twice is expected to yield different obfuscated outputs, as randomly sampling from the learned noise distributions is expected to produce different values each time. The stochastic noise layer may apply noise to some components of the representation of the dataset D and not others and may apply different distributions and intensities of noise to one or more components of the representation of the dataset D at each stochastic noise layer. In some cases, noise may be additive, subtractive, multiplicative, or divisive. The added noise may be linear, super linear, sublinear, a ratio, etc. The noise may be nonlinear noise. The parameters of the noise may be determined for a maximum obfuscation with minimum additional reconstruction losses using the techniques discussed above and in U.S. patent application Ser. No. 17/458,165. The noise parameters may be determined based on stochastic gradient descent, or any other appropriate method.

Once the noise layer has been trained, sections of the autoencoder may be pruned, e.g., the decoder. The encoder, together with one or more stochastic layers, may be used to generate obfuscated training data set, e.g., dataset D′, D″, etc., such that the un-obfuscated training data set D is protected from disclosure to a party that merely has D′. For example, the encoder may execute at a trusted position on the repository of training data to generate an obfuscated dataset D′, which is then transmitted or otherwise communicated to a model training algorithm in an untrusted environment. In some embodiments, the encoder may operate within the envelope of the training data or trusted storage vehicle and encode training data before it leaves the trusted envelope, where the trusted envelope may be a storage location, a customer site, etc. The terms “trusted” and “untrusted” are not used in the subjective sense, and no state of mind or judgement is required. Rather the terms refer to distinct computing environments where privileges in one do not necessarily afford full access in the other.

The encoder may also be used to generate augmented training data, where the stochastic noise layer may generate one or more distributions which may be used to generate multiple obfuscated elements for the dataset D′ from one element of the dataset D. Each of the elements of the obfuscated dataset D′ may be generated based on one element of the dataset D. In this way data may be characterized as being quasi-synthetic, e.g., realistic but obfuscated, and not necessarily wholly synthetic. Parameters of the elements of the dataset D′ may be synthetic (e.g., obfuscated, noisy, or otherwise not measured quantities) but the elements of the dataset D′ may correspond to single elements, such as a tensor X, or the original dataset D. Components of various elements, (e.g., tensors X) may not be swapped between each other to generate fully synthetic data which may or may not be realistic. As data is quasi-synthetic, a model may be trained on the dataset D′ as if the obfuscated dataset D′ was the un-obfuscated dataset D.

In some embodiments, additional constraints may be applied through noise regularization. For example, a sensitive parameter may be regularized or made uniform such that the parameter is not present and/or cannot be reconstructed from the dataset D′. Regularization may also be used to reduce bias. An adversarial loss model or an adversarial term may be added to prevent another model from predicting sensitive attributes which have been obscured. For example, for tabular data an element representing gender may be regularized, such that the dataset D′ has a normalized and/or uniform distribution of gender variables. Based on data security requirements and/or data engineering, features which are to be regularized and/or removed may be identified. In some cases, a feature, such as gender, may also influence other features of the data, such as occupation. In order to fully obfuscate one feature, additional features may also be regularized. The rate of regularization or amount of obfuscation may depend on data security needs and/or on the relationship and dependence between features.

In some cases, a maximum noise applied in a stochastic noise layer may also be determined based on a subsequent machine learning model. A machine learning model trained on obfuscated dataset D′ may be tested for error, based on a test accuracy, a test data set, a validation data set, etc. In instances where the subsequent machine learning model accuracy is affected by the stochastic noise layer, the noise layer may be reduced or adjusted in order to produce an obfuscated dataset valid for model training. In some embodiments, the autoencoder may also or instead be retrained.

Some embodiments augment otherwise deterministic autoencoders and/or neural networks with stochastic conditional noise layers. Examples with stochastic noise layers include architectures in which the parameters of the layers (e.g., layer weights) are each a distribution (from which values are randomly (which includes pseudo-randomly) drawn to process a given input) instead of deterministic values. In some examples, the parameters of the layers (e.g., layer weights) are single values but when applied to their inputs instead of generating the output of the layer, the output of the layer sets the parameters of a set of corresponding distributions that are sampled from to generate the output. In some cases, a plurality of parallel stochastic noise layers may output to a downstream conditional layer configured to select an output (e.g., one output, or apply weights to each in accordance with relevance to the classification) among the outputs of the upstream parallel stochastic noise layers. In some cases, for a given input, one parallel stochastic noise layer may be upweighted in one sub-region of the given input (like a collection of contiguous pixels in an image) while another parallel stochastic noise layer is downweighted in the same sub-region, and then this relationship may be reversed in other sub-regions of the same given input.

In some embodiments, un-obfuscated training data may reside at a “trusted” computing device, process, container, virtual machine, OS protection ring, or sensor, and training may be performed on an “untrusted” computing device, process, container, virtual machine, or OS protection ring. The term “trust” in this example does not specify a state of mind, merely a designation of a boundary across which training data information flow from trusted source to untrusted destination is to be reduced with some embodiments of the present techniques. The training data may be encoded by the encoder of the autoencoder together with the stochastic noise layers. When the autoencoder is trained, the encoder may be constrained versus the decoder so that the encoder requires smaller computing time/energy than the decoder (e.g., such that the encoder contains smaller or fewer layers than the decoder). As the encoder may be added to the secure data storage and operate upon the trusted training data before the training data is transmitted or used, a smaller encoder is computationally advantageous. The data may be obfuscated through the stochastic operation of the layer, through random selection of distributions corresponding to model parameters, as discussed elsewhere herein. The obfuscated training data may be proved to the untrusted destination where model training continues on the obfuscated data. Consequently, the untrusted computing device, process, container, virtual machine, or OS protection ring performing training is prevented from, and need not, access the un-obfuscated training data.

Reference to “minimums” and “maximums” should not be read as limited to finding these values with absolute precision and includes approximating these values within ranges that are suitable for the use case and adopted by practitioners in the field. It is generally not feasible to compute “minimums” or “maximums” to an infinite number of significant digits and spurious claim construction arguments to this effect should be rejected.

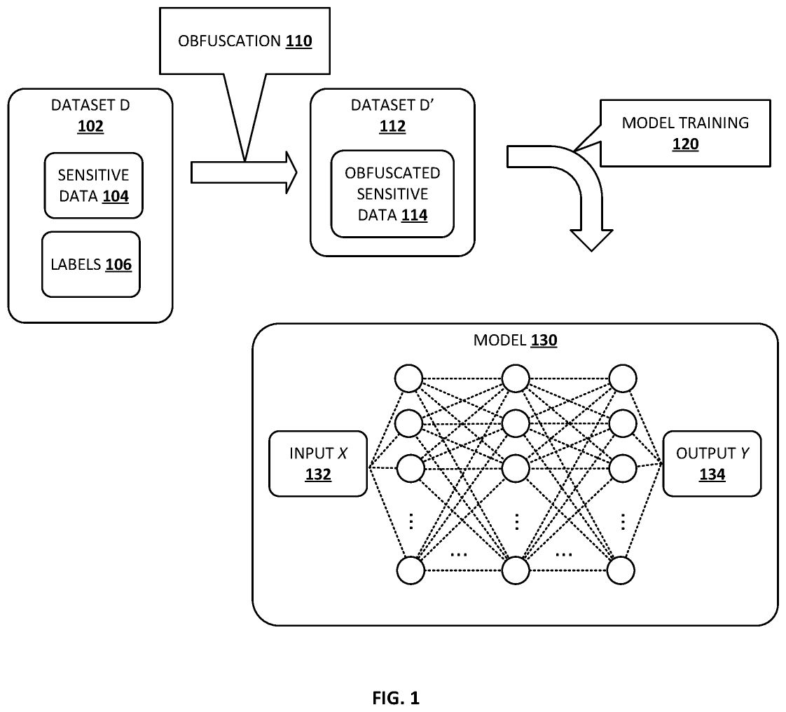

The forgoing embodiments may be implemented in connection with example systems and techniques depicted in FIGS. 1-8. It should be emphasized, though, that the figures depict certain embodiments and should not be read as limiting.

Machine learning models have emerged as powerful and effective solutions for a variety of tasks from e-commerce to healthcare. In a number of use-cases, machine learning algorithms, particularly Deep Neural Networks, have even surpassed human performance. As such, these models have penetrated everyday applications such as voice assistants and aspire to even unlock self-driving cars and delivery services. To this end, the security of the data used to train these models and their susceptibility to any form of malevolent actions needs to be considered with utmost rigor.

Data obfuscation may be presented as a gradient-based optimization that defines a loss function over a pre-trained machine learning model. This loss may be defined as finding the minimum perturbation (noise) over the input to the model that causes minimum reconstruction losses in the objective of the model without changing its parameters. For instance, find the maximum perturbation that causes minimum reconstruction loss without changing the weights of the model. Some embodiments are described as applied to neural network models. The idea is not limited to any specific type of neural network or data type. For instance, it may be applied on neural networks that operate on image data for vision tasks. Or it may be applied to neural networks that process text of an email to detect whether or not it is spam. These are just examples of use-cases and the technique is general and may be applied to other types of models.

FIG. 1 depicts an example machine learning model 130 trained using an obfuscated dataset D′ 112. The machine learning model 130 may be trained by any appropriate training method, including model training 120. The machine learning model 130 may operate on an input X 132, which may be an element of the obfuscated dataset D′ 112. The machine learning model 130 may output an output Y 134 based on the input. The machine learning model may be any appropriate machine learning model.

The obfuscated dataset D′ 112 may be an obfuscated version of the dataset D 102. The dataset D 102 may contain sensitive data 104 (e.g., data which is identified as to be obfuscated, including partially, fully, removed from inference-ability, etc.). The dataset D 102 may contain labels 106. An obfuscation operation 110 may be performed on the dataset D 102 to produce the obfuscated dataset D′ 112. The obfuscation operation 110 may remove the labels 106 and the sensitive data 104 from the obfuscated dataset D′ 112. Each element of the dataset D 102 may be used to create one or more element of the obfuscated dataset D′ 112. For example, by application of stochastic noise, which may be sampled multiple times creating different values, an element of the dataset D 102 may be used to generate multiple elements of the obfuscated dataset D′ 112. The obfuscated dataset D′ 112 may be used to train the machine learning model 130.

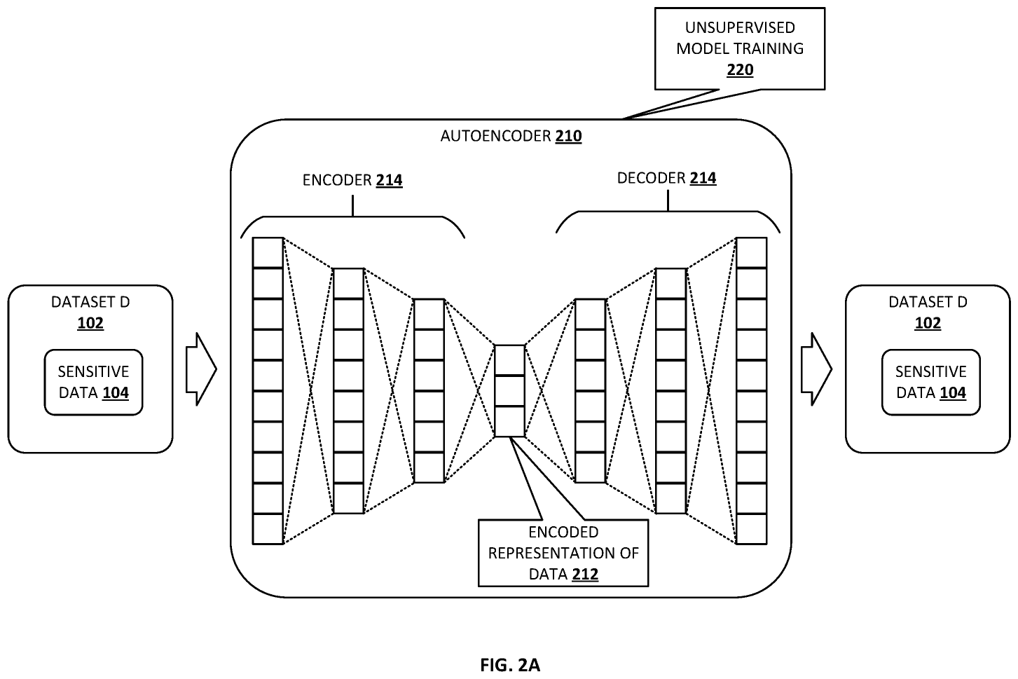

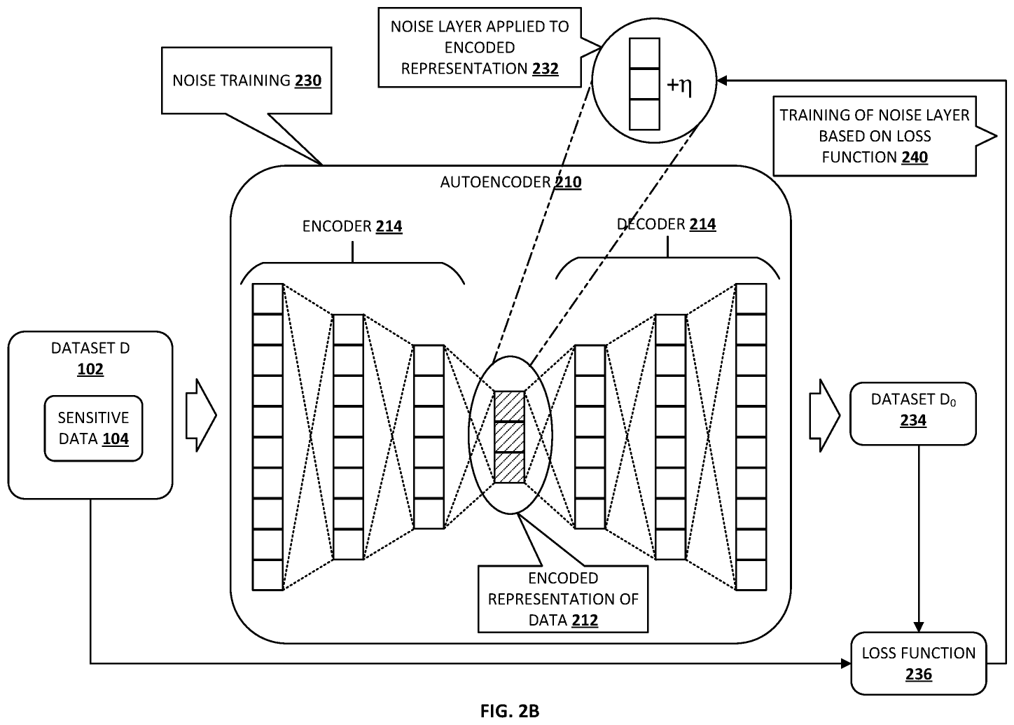

FIG. 2A depicts a system for encoding a representation of data using an autoencoder 210. The dataset D 102 may be used to train an autoencoder. The dataset D 102 may be used without labels, e.g., in an unsupervised manner, to train the autoencoder to generate an encoded representation of data 212. The encoded representation of data 212 may be a latent representation. The autoencoder 212 may contain an encoder 214 and a decoder 214, which may operate upstream and downstream of a bottleneck layer. The autoencoder may be trained, using an appropriate method of unsupervised model training 220, to generate an output of dataset D 102 based on an input of dataset D 102. The autoencoder 210 may be trained using a reconstruction loss function.

FIG. 2B depicts a system for applying noise to an encoded representation of data in the autoencoder 210. Noise, which may be in the form of a stochastic noise layer, may be applied to an encoded representation of the data 212 within the autoencoder 210. An application of noise to the bottleneck layer is depicted, but noise may be applied at one or more layer which may or may not be the bottleneck layer. The noise applied to the encoded representation 232 may be trained (e.g., in noise training 230), such as by using a loss function 236. An example loss function is depicted in Equation 1, below:

$${min}_{η} {X \sim D}_{} [ ( X \vert θ , η ) + {αℒ}_{n o i s e} ( η ) ] \qquad ( 1 )$$

where [symbol] is a reconstruction loss, such as may be used to train an autoencoder, θ are the autoencoder parameters, η are the noise parameters, a is an adjustable noise tuning parameter, and [symbol] is a loss due to noise. The loss function, or another appropriate optimization objective, may be minimized (or maximized if a gain function is used) to determine parameters for the noise. The loss function 236 may be determined based on input of elements of the dataset D 102 into the autoencoder 210, with the noise layer applied to the encoded representation 212, which may produce an output dataset DO 234. The output dataset DO 234 and the dataset D 102 may be used to determine values of the loss function 236. The noise layer applied to the encoded representation 232 may be trained based on the loss function 240.

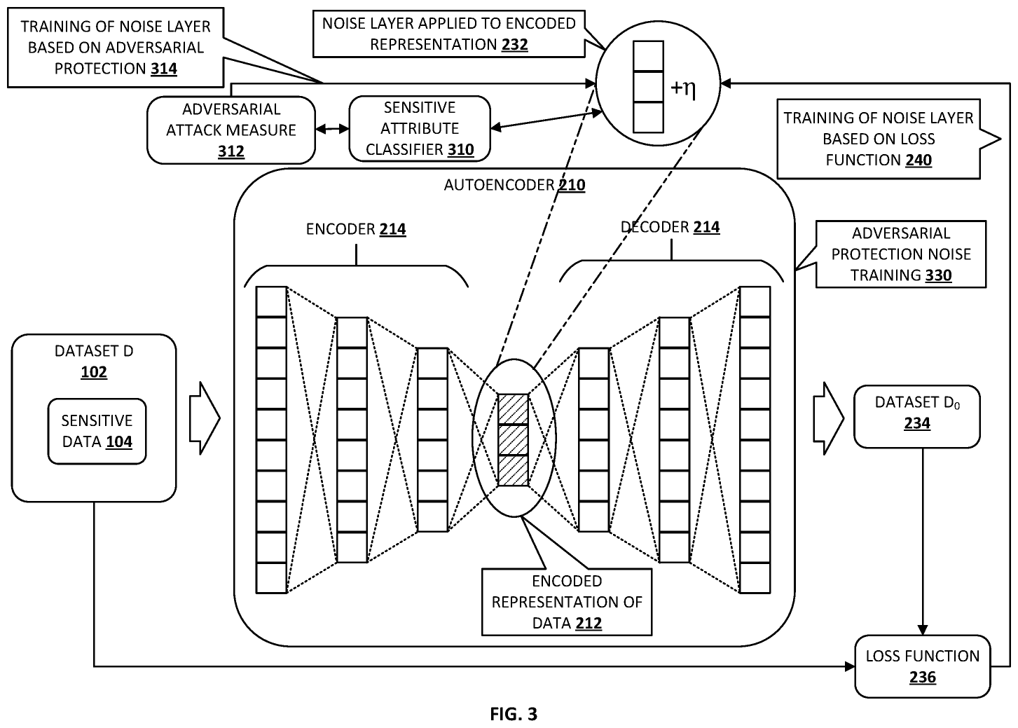

FIG. 3 depicts a system for obfuscation of sensitive attributes while applying noise to an encoded representation of data. Adversarial protection noise training 330 may tune the applied noise such that the sensitive data 104 of the dataset D 102 is protected. Sensitive data 104 may be identified in the dataset D 102 an intentionally obfuscated (e.g., protected). The sensitive data 104 may be identified additional constraints to the noise may be applied through noise regularization. For example, an additional adversarial attack measure 312 may be determined, which may be used to measure the prevalence of the sensitive data 104 within the encoded representation of the data 212. A sensitive attribute classifier 310, which may be an inference model trained to infer the sensitive data 104 from the encoded representation of the data 212, may be applied to the encoded representation of the data 212. The sensitive attribute classifier 310 may determine the adversarial attack measure 312, which may be a measure of how likely an adversarial attack is to be successful at recreating the sensitive data 104. An appropriate method and measure of sensitive data 104 content within the encoded representation of the data 212 may be used. The nose layer may be trained based on adversarial protection 314 by any appropriate method, such as by using an adversarial term to the loss function, such as by using Equation 2, below:

$${min}_{η} {X \sim D}_{} [ ( X \vert θ , η ) + {αℒ}_{n o i s e} ( η ) + {βℒ}_{a d v} ( X \vert η , θ , Ω ) ] \qquad ( 1 )$$

where Ω are parameters of an adversarial model, [symbol] is the adversarial loss, and β is an adjustable noise tuning parameter. The loss function, or another appropriate optimization objective, may be minimized (or maximized if a gain function is used) to determine parameters for the noise which protect the sensitive data 104.

The differentiability of these formulations may be important to the ability to train noise for data obfuscation, where obfuscated data retains training abilities. Because of this characteristic, gradient descent algorithms (e.g., stochastic gradient descent) may be used to find the perturbations (σs) which give the maximum perturbation which produce the minimum reconstruction loss. This class of algorithms are conventionally used to train neural networks and discover the weights. However, the neural network (e.g., autoencoder) may be pre-trained and the weight parameters already known. Therefore, in optimization, the gradients may be calculated with respect to the perturbations (σs) that leads to the discovery of the maximum noise.

In another embodiment, the perturbations may be applied to the intermediate representations or the layers of the machine learning model.

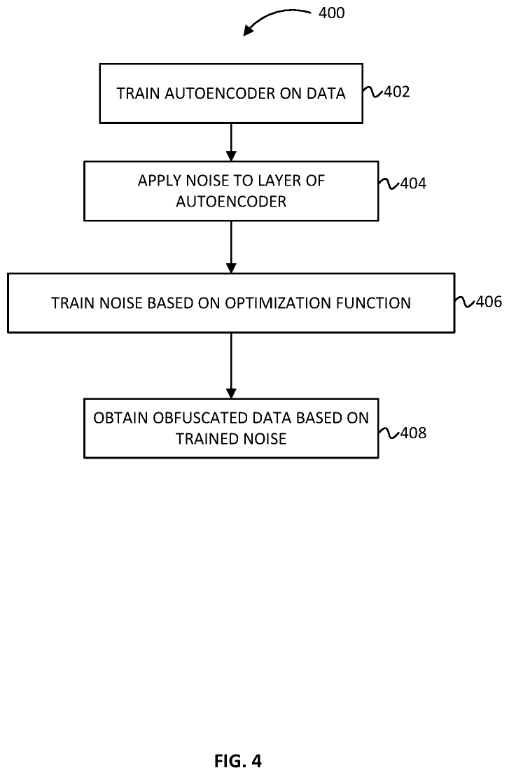

FIG. 4 illustrates an exemplary method 400 for data obfuscation with limited supervision. Each of these operations is described in detail below. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting. In some embodiments, one or more portions of method 400 may be implemented (e.g., by simulation, modeling, etc.) in one or more processing devices (e.g., one or more processors). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400, for example. For illustrative purposes, optional operations are depicted with dashed lines. However, operations which are shown with unbroken lines may also be optional or may be omitted.

At an operation 402, an autoencoder is trained on data. The autoencoder may instead be another unsupervised machine learning model. The autoencoder may be obtained, instead of trained, such as obtained from storage. The autoencoder may be comprised of an encoder and a decoder. The encoder and the decoder may be symmetrical or asymmetrical, in size, number of layers, etc. The autoencoder may be partially trained, fully trained, untrained, etc. The autoencoder may instead be another unsupervised or self-supervised model in which data is encoded into a latent representation. The autoencoder may be trained on a set of training data. The data may instead be another type of data, such as inference data, data for re-training, data for additional training, etc. The data may be any appropriate type of data, such as image data, tabular data, etc. Parameters of the trained autoencoder may be stored.

At an operation 404, noise is applied to one or more layer of the autoencoder. The noise may be applied as a stochastic noise layer. Noise may be applied to multiple layers. Noise may be applied to layers of the encoder while not applied to layers of the decoder.

At an operation 406, noise may be trained based on an optimization function. The optimization function may be a loss function. The optimization function may be determined based on output of the autoencoder. The optimization function may be determined based on output of the encoder, the decoder, both the encoder and the decoder, etc. The optimization function may a reconstruction loss, which may be the reconstruction loss used to train the autoencoder. The optimization function may include a noise loss. The relative contribution of the noise loss to the optimization function may be adjusted by application of a tuning parameter. The optimization function may include noise regularization. The optimization function may include an adversarial loss, which may be a measure of the ability of another model to extract sensitive data from the output of the autoencoder or a representation of the data of the autoencoder. The optimization parameters may be any of those optimization parameters previously described, including gradient descent, back propagation, etc. The stochastic layer may be trained until a training criterion is satisfied, which may be a time limit, a number of iterations, a loss function, etc. If the machine learning model is untrained, the stochastic layer may be trained during the training of the machine learning model.

At an operation 408, obfuscated data is obtained based on the trained noise. The obfuscated data may be obtained from the encoder of the autoencoder. The obfuscated data may be obtained from the encoder. The obfuscated data may include quasi-synthetic data, or multiple elements corresponding to different applications of stochastic noise to the dame element of the un-obfuscated dataset. The obfuscated data may be stored. The parameters of the noise used to create the obfuscated data may be stored. The parameters of the autoencoder, with or without the noise, may be stored. As described above, method 400 (and/or the other methods and systems described herein) is configured to provide a generic framework for obfuscation of data with limited supervision, where limited supervision includes unsupervised obfuscation, self-supervised obfuscation, etc.

Examples of noise distributions and stochastic gradient methods that may be used to find minimum or maximum perturbations are described in U.S. Provisional Pat. App. 63/227,846, titled STOCHASTIC LAYERS, filed 30 Jul. 2021 (describing examples of stochastic layers with properties like those relevant here); U.S. Provisional Pat. App. 63/221,738, titled REMOTELY-MANAGED, NEAR-STORAGE OR NEAR-MEMORY DATA TRANSFORMATIONS, filed 14 Jul. 2021 (describing data transformations that may be used with the present techniques, e.g., on training data); and U.S. Provisional Pat. App. 63/153,284, titled METHODS AND SYSTEMS FOR SPECIALIZING DATASETS FOR TRAINING/VALIDATION OF MACHINE LEARNING, filed 24 Feb. 2021 (describing examples of obfuscation techniques that may be used with the present techniques); each of which is hereby incorporated by reference.

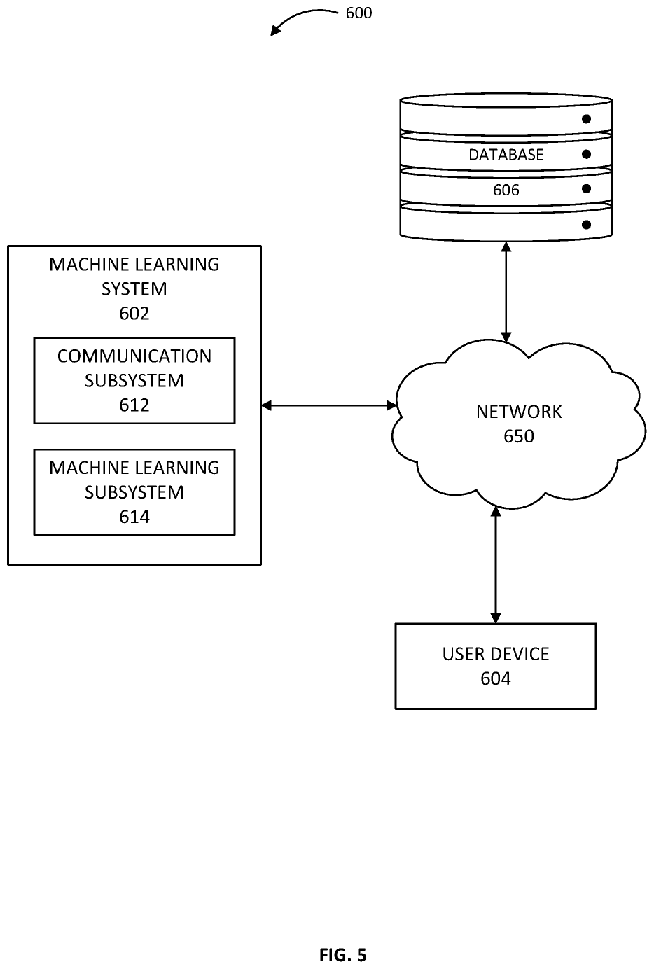

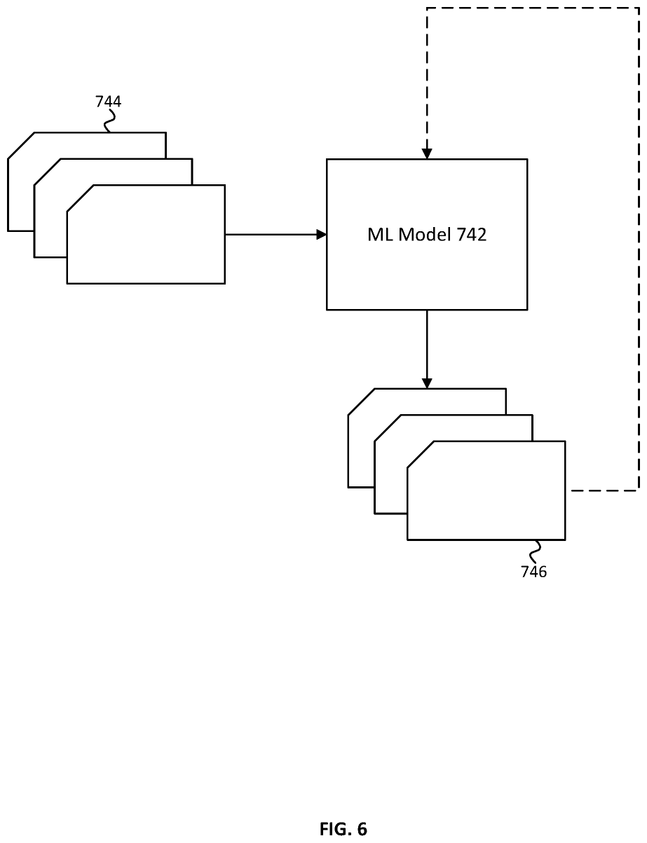

FIG. 5 shows an example computing system 600 for implementing data obfuscation in machine learning models. The computing system 600 may include a machine learning (ML) system 602, a user device 604, and a database 606. The ML system 602 may include a communication subsystem 612, and a machine learning (ML) subsystem 614. The communication subsystem 612 may retrieve one or more datasets from the database 606 for use in training or performing inference via the ML subsystem 614 (e.g., using one or more machine-learning models described in connection with FIG. 6).

One or more machine learning models used (e.g., for training or inference) by the ML subsystem 614 may include one or more stochastic layers. The machine learning model used by the ML subsystem 614 may be an autoencoder and/or comprise at least one of an encoder and decoder. A stochastic layer may receive input from a previous layer (e.g., in a neural network or other machine learning model) and output data to subsequent layers, for example, in a forward pass of a machine learning model. A stochastic layer may take first data as input and perform one or more operations on the first data to generate second data. For example, the stochastic layer may be a stochastic convolutional layer with a first filter that corresponds to the mean of a normal distribution and a second filter that corresponds to the standard deviation of the normal distribution. The second data may be used as parameters of a distribution (e.g. or may be used to define parameters of a distribution). For example, the second data may include data (e.g., data indicating the mean of the normal distribution) that is generated by convolving the first filter over an input image. In this example, the second data may include data (e.g., data indicating the standard deviation of the normal distribution) that is generated by convolving the second filter over the input image.

One or more values may be sampled from the distribution. The one or more values may be used as input to a subsequent layer (e.g., the next layer following the stochastic layer in a neural network). For example, the mean generated via the first filter and the standard deviation generated via the second filter (e.g., as discussed above) may be used to sample one or more values. The one or more values may be used as input into a subsequent layer. The subsequent layer may be a stochastic layer (e.g., a stochastic convolution layer, stochastic fully connected layer, stochastic activation layer, stochastic pooling layer, stochastic batch normalization layer, stochastic embedding layer, or a variety of other stochastic layers) or a non-stochastic layer (e.g., convolution, fully-connected, activation, pooling, batch normalization, embedding, or a variety of other layers).

A stochastic layer or one or more parameters of a stochastic layer may be trained via gradient descent (e.g., stochastic gradient descent) and backpropagation, or a variety of other training methods. One or more parameters may be trained, for example, because the one or more parameters are differentiable with respect to one or more other parameters of the machine learning model. For example, the mean of the normal distribution may be differentiable with respect to the first filter (e.g., or vice versa). As an additional example, the standard deviation may be differentiable with respect to the second filter (e.g., or vice versa).

In some embodiments, one or more parameters of a stochastic layer may be represented by a probability distribution. For example, a filter in a stochastic convolution layer may be represented by a probability distribution. The ML subsystem 614 may generate a parameter (e.g., a filter or any other parameter) of a stochastic layer by sampling from a corresponding probability distribution.

In some embodiments, the system determines a maximum noise variance causing a minimum reconstruction loss on the neural network. The maximum noise variance is a differentiable output. To obtain the maximum noise variance value, the system calculates gradients using gradient descent algorithms (e.g., stochastic gradient descent) on a pre-trained neural network. As the neural network is pre-trained with known weight parameters, the optimization calculates the gradients with respect to the minimum noise variance (e.g., perturbations).

In some embodiments, the maximum noise variance may be determined as described herein and applied to one or more intermediate layers of a machine learning model.

In some embodiments, the maximum noise variance may be constrained by a maximum reconstruction loss value. The maximum reconstruction loss value may depend on the type of model as a subsequent machine learning model which is to be trained on the obfuscated data. The maximum reconstruction loss value may be variable.

The user device 604 may be a variety of different types of computing devices, including, but not limited to (which is not to suggest that other lists are limiting), a laptop computer, a tablet computer, a hand-held computer, smartphone, other computer equipment (e.g., a server or virtual server), including “smart,” wireless, wearable, Internet of Things device, or mobile devices. The user device 604 may be any device used by a healthcare professional (e.g., a mobile phone, a desktop computer used by healthcare professionals at a medical facility, etc.). The user device 604 may send commands to the ML system 602 (e.g., to train a machine-learning model, perform inference, etc.). Although only one user device 604 is shown, the system 600 may include any number of client devices.

The ML system 602 may include one or more computing devices described above and may include any type of mobile terminal, fixed terminal, or other device. For example, the ML system 602 may be implemented as a cloud computing system and may feature one or more component devices. Users may, for example, utilize one or more other devices to interact with devices, one or more servers, or other components of system 600. In some embodiments, operations described herein as being performed by particular components of the system 600, may be performed by other components of the system 600 (which is not to suggest that other features are not also amenable to variation). As an example, while one or more operations are described herein as being performed by components of the ML system 602, those operations may be performed by components of the user device 604 or database 606. In some embodiments, the various computers and systems described herein may include one or more computing devices that are programmed to perform the described functions. In some embodiments, multiple users may interact with system 600. For example, a first user and a second user may interact with the ML system 602 using two different user devices.

One or more components of the ML system 602, user device 604, and database 606, may receive content and other data via input/output (hereinafter “I/O”) paths. The one or more components of the ML system 602, the user device 604, and/or the database 606 may include processors and/or control circuitry to send and receive commands, requests, and other suitable data using the I/O paths. The control circuitry may include any suitable processing, storage, and/or input/output circuitry. Each of these devices may include a user input interface and/or user output interface (e.g., a display) for use in receiving and displaying data. It should be noted that in some embodiments, the ML system 602, the user device 604, and the database 606 may have neither user input interface nor displays and may instead receive and display content using another device (e.g., a dedicated display device such as a computer screen and/or a dedicated input device such as a remote control, mouse, voice input, etc.). Additionally, the devices in system 600 may run an application (or another suitable program). The application may cause the processors and other control circuitry to perform operations related to weighting training data (e.g., to increase the efficiency of training and performance of one or more machine-learning models described herein).

One or more components or devices in the system 600 may include electronic storages. The electronic storages may include non-transitory storage media that electronically stores information. The electronic storage media of the electronic storages may include one or both of (a) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), or other electronically, magnetically, or optically readable storage media. The electronic storages may include one or more virtual storage resources (e.g., cloud storage, a virtual private network, or other virtual storage resources). The electronic storages may store software algorithms, information determined by the processors, information obtained from servers, information obtained from client devices, or other information that enables the functionality as described herein.

FIG. 5 also includes a network 650. The network 650 may be the Internet, a mobile phone network, a mobile voice or data network (e.g., a 5G or LTE network), a cable network, a public switched telephone network, a combination of these networks, or other types of communications networks or combinations of communications networks. The devices in FIG. 5 (e.g., ML system 602, the user device 604, and/or the database 606) may communicate (e.g., with each other or other computing systems not shown in FIG. 5) via the network 650 using one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The devices in FIG. 5 may include additional communication paths linking hardware, software, and/or firmware components operating together. For example, the ML system 602, any component of the ML system 602 (e.g., the communication subsystem 612 or the ML subsystem 614), the user device 604, and/or the database 606 may be implemented by one or more computing platforms.

One or more machine-learning models that are discussed above (e.g., in connection with FIG. 5 or the technical documentation) may be implemented, for example, as shown in FIG. 6. With respect to FIG. 6, machine-learning model 742 may take inputs 744 and provide outputs 746.

In some use cases, outputs 746 may be fed back to machine-learning model 742 as input to train machine-learning model 742 (e.g., alone or in conjunction with user indications of the accuracy of outputs 746, labels associated with the inputs, or with other reference feedback and/or performance metric information). In another use case, machine-learning model 742 may update its configurations (e.g., weights, biases, or other parameters) based on its assessment of its prediction (e.g., outputs 746) and reference feedback information (e.g., user indication of accuracy, reference labels, or other information). In another example use case, where machine-learning model 742 is a neural network and connection weights may be adjusted to reconcile differences between the neural network's output and the reference feedback. In some use cases, one or more perceptrons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine-learning model 742 may be trained to generate results (e.g., response time predictions, sentiment identifiers, urgency levels, etc.) with better recall, accuracy, or precision.

In some embodiments, the machine-learning model 742 may include an artificial neural network (“neural network” herein for short). In such embodiments, machine-learning model 742 may include an input layer (e.g., a stochastic layer as described in connection with FIG. 5) and one or more hidden layers (e.g., a stochastic layer as described in connection with FIG. 5). Each neural unit of the machine-learning model may be connected with one or more other neural units of the machine-learning model 742. Such connections may be enforcing or inhibitory in their effect on the activation state of connected neural units. Each individual neural unit may have a summation function which combines the values of one or more of its inputs together. Each connection (or the neural unit itself) may have a threshold function that a signal must surpass before it propagates to other neural units. The machine-learning model 742 may be self-learning (e.g., trained), rather than explicitly programmed, and may perform significantly better in certain areas of problem solving, as compared to computer programs that do not use machine learning. During training, an output layer (e.g., a stochastic layer as described in connection with FIG. 5) of the machine-learning model 742 may correspond to a classification, and an input (e.g., any of the data or features described in the machine learning specification above) known to correspond to that classification may be input into an input layer of machine-learning model during training. During testing, an input without a known classification may be input into the input layer, and a determined classification may be output. The machine-learning model 742 trained by the ML subsystem 614 may include one or more embedding layers (e.g., a stochastic layer as described in connection with FIG. 5) at which information or data (e.g., any data or information discussed above in connection with the machine learning specification) is converted into one or more vector representations. The one or more vector representations of the message may be pooled at one or more subsequent layers (e.g., a stochastic layer as described in connection with FIG. 5) to convert the one or more vector representations into a single vector representation.

The machine-learning model 742 may be structured as a factorization machine model. The machine-learning model 742 may be a non-linear model and/or (use of which should not be read to suggest that other uses of “or” mean “xor”) supervised learning model that may perform classification and/or regression. For example, the machine-learning model 742 may be a general-purpose supervised learning algorithm that the system uses for both classification and regression tasks. Alternatively, the machine-learning model 742 may include a Bayesian model configured to perform variational inference given any of the inputs 744. The machine-learning model 742 may be implemented as a decision tree, as an ensemble model (e.g., using random forest, bagging, adaptive booster, gradient boost, XGBoost, etc.), or any other machine-learning model.

The machine-learning model 742 may be a reinforcement learning model. The machine-learning model 742 may take as input any of the features described above (e.g., in connection with the machine learning specification) and may output a recommended action to perform. The machine-learning model may implement a reinforcement learning policy that includes a set of actions, a set of rewards, and/or a state.

The reinforcement learning policy may include a reward set (e.g., value set) that indicates the rewards that the machine-learning model obtains (e.g., as the result of the sequence of multiple actions). The reinforcement learning policy may include a state that indicates the environment or state that the machine-learning model is operating in. The machine-learning model may output a selection of an action based on the current state and/or previous states. The state may be updated at a predetermined frequency (e.g., every second, every 2 hours, or a variety of other frequencies). The machine-learning model may output an action in response to each update of the state. For example, if the state is updated at the beginning of each day, the machine-learning model 742 may output an action to take based on the action set and/or one or more weights that have been trained/adjusted in the machine-learning model 742. The state may include any of the features described in connection with the machine learning specification above. The machine-learning model 742 may include a Q-learning network (e.g., a deep Q-learning network) that implements the reinforcement learning policy described above.

In some embodiments, the machine-learning models may include a Bayesian network, such as a dynamic Bayesian network trained with Baum-Welch or the Viterbi algorithm. Other models may also be used to account for the acquisition of information over time to predict future events, e.g., various recurrent neural networks, like long-short-term memory models trained on gradient descent after loop unrolling, reinforcement learning models, and time-series transformer architectures with multi-headed attention. In some embodiments, some or all of the weights or coefficients of models described herein may be calculated by executing a machine learning algorithm on a training set of historical data. Some embodiments may execute a gradient descent optimization to determine model parameter values. Some embodiments may construct the model by, for example, assigning randomly selected weights; calculating an error amount with which the model describes the historical data and a rate of change in that error as a function of the weights in the model in the vicinity of the current weight (e.g., a derivative, or local slope); and incrementing the weights in a downward (or error reducing) direction. In some cases, these steps may be iteratively repeated until a change in error between iterations is less than a threshold amount, indicating at least a local minimum, if not a global minimum. To mitigate the risk of local minima, some embodiments may repeat the gradient descent optimization with multiple initial random values to confirm that iterations converge on a likely global minimum error. Other embodiments may iteratively adjust other machine learning models to reduce the error function, e.g., with a greedy algorithm that optimizes for the current iteration. The resulting, trained model, e.g., a vector of weights or thresholds, may be stored in memory and later retrieved for application to new calculations on newly calculated aggregate estimates.

In some cases, the amount of training data may be relatively sparse. This may make certain models less suitable than others. In such cases, some embodiments may use a triplet loss network or Siamese networks to compute similarity between out-of-sample records and example records in a training set, e.g., determining based on cosine distance, Manhattan distance, or Euclidian distance of corresponding vectors in an encoding space (e.g., with more than 5 dimensions, such as more than 50).

Run time may process inputs outside of a training set and may be different from training time, except for in use cases like active learning. Random selection includes pseudorandom selections. In some cases, the neural network may be relatively large, and the portion that is non-deterministic may be a relatively small portion. The neural network may have more than 10, 50, or 500 layers, and the number of stochastic layers may be less than 10, 5, or 3, in some cases. In some cases, the number of parameters of the neural network may be greater than 10,000; 100,000; 1,000,000; or 10,000,000; while the number of stochastic parameters may be less than 10%, 5%, 1%, or 0.1% of that. This is expected to address problems that arise when traditional probabilistic neural networks attempt to scale, which with many approaches, produces undesirably excessive scaling in memory or run time complexity. Other benefits expected of some embodiments include enhanced interpretability of trained neural networks based on statistical parameters of trained stochastic layers, the values of which may provide insight (e.g., through visualization, like by color coding layers or components thereof according to values of statistical parameters after training) into the contribution of various features in outputs of the neural network, enhanced privacy from injecting noise with granularity into select features or layers of the neural network making downstream layers our outputs less likely to leak information, and highlighting layers or portions thereof for pruning to compress neural networks without excessively impairing performance by removing those components that the statistical parameters indicate are not contributing sufficiently to performance. In some cases, the stochastic layers may be partially or fully constituted of differential parameters adjusted during training, which is expected to afford substantial benefits in terms of computational complexity during training relative to models with non-differentiable parameters. That said, embodiments are not limited to systems affording all of these benefits, which is not to suggest that any other description is limiting.

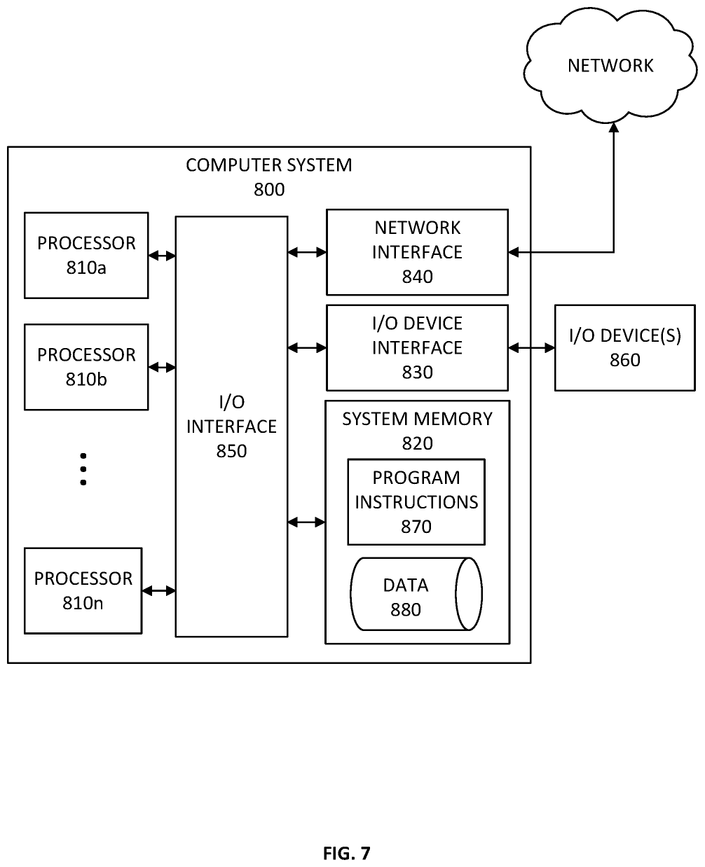

FIG. 7 is a diagram that illustrates an exemplary computing system 800 in accordance with embodiments of the present technique. Various portions of systems and methods described herein, may include or be executed on one or more computer systems similar to computing system 800. Further, processes and modules described herein may be executed by one or more processing systems similar to that of computing system 800.

Computing system 800 may include one or more processors (e.g., processors 810a-810n) coupled to system memory 820, an input/output I/O device interface 830, and a network interface 840 via an input/output (I/O) interface 850. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 800. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 820). Computing system 800 may be a units-processor system including one processor (e.g., processor 810a), or a multi-processor system including any number of suitable processors (e.g., 810a-810n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 800 may include a plurality of computing devices (e.g., distributed computer systems) to implement various processing functions.

I/O device interface 830 may provide an interface for connection of one or more I/O devices 860 to computing system 800. I/O devices may include devices that receive input (e.g., from a user) or output information (e.g., to a user). I/O devices 860 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 860 may be connected to computing system 800 through a wired or wireless connection. I/O devices 860 may be connected to computing system 800 from a remote location. I/O devices 860 located on remote computer system, for example, may be connected to computing system 800 via a network and network interface 840.

Network interface 840 may include a network adapter that provides for connection of computing system 800 to a network. Network interface 840 may facilitate data exchange between computing system 800 and other devices connected to the network. Network interface 840 may support wired or wireless communication. The network may include an electronic communication network, such as the Internet, a local area network (LAN), a wide area network (WAN), a cellular communications network, or the like.

System memory 820 may be configured to store program instructions 870 or data 880. Program instructions 870 may be executable by a processor (e.g., one or more of processors 810a-810n) to implement one or more embodiments of the present techniques. Instructions 870 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 820 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 820 may include a non-transitory computer readable storage medium that may have program instructions stored thereon that are executable by a computer processor (e.g., one or more of processors 810a-810n) to cause the subject matter and the functional operations described herein. A memory (e.g., system memory 820) may include a single memory device and/or a plurality of memory devices (e.g., distributed memory devices).

I/O interface 850 may be configured to coordinate I/O traffic between processors 810a-810n, system memory 820, network interface 840, I/O devices 860, and/or other peripheral devices. I/O interface 850 may perform protocol, timing, or other data transformations to convert data signals from one component (e.g., system memory 820) into a format suitable for use by another component (e.g., processors 810a-810n). I/O interface 850 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 800 or multiple computer systems 800 configured to host different portions or instances of embodiments. Multiple computer systems 800 may provide for parallel or sequential processing/execution of one or more portions of the techniques described herein.

Those skilled in the art will appreciate that computing system 800 is merely illustrative and is not intended to limit the scope of the techniques described herein. Computing system 800 may include any combination of devices or software that may perform or otherwise provide for the performance of the techniques described herein. For example, computing system 800 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 800 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 800 may be transmitted to computing system 800 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present disclosure may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several disclosures. Rather than separating those disclosures into multiple isolated patent applications, applicants have grouped these disclosures into a single document because their related subject matter lends itself to economies in the application process. But the distinct advantages and aspects of such disclosures should not be conflated. In some cases, embodiments address all of the deficiencies noted herein, but it should be understood that the disclosures are independently useful, and some embodiments address only a subset of such problems or offer other, unmentioned benefits that will be apparent to those of skill in the art reviewing the present disclosure. Due to costs constraints, some features disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such disclosures or all aspects of such disclosures.

It should be understood that the description and the drawings are not intended to limit the disclosure to the particular form disclosed, but to the contrary, the intention is to cover all modifications, equivalents, and alternatives falling within the spirit and scope of the present disclosure as defined by the appended claims. Further modifications and alternative embodiments of various aspects of the disclosure will be apparent to those skilled in the art in view of this description. Accordingly, this description and the drawings are to be construed as illustrative only and are for the purpose of teaching those skilled in the art the general manner of carrying out the disclosure. It is to be understood that the forms of the disclosure shown and described herein are to be taken as examples of embodiments. Elements and materials may be substituted for those illustrated and described herein, parts and processes may be reversed or omitted, and certain features of the disclosure may be utilized independently, all as would be apparent to one skilled in the art after having the benefit of this description of the disclosure. Changes may be made in the elements described herein without departing from the spirit and scope of the disclosure as described in the following claims. Headings used herein are for organizational purposes only and are not meant to be used to limit the scope of the description.

As used throughout this application, the word “may” is used in a permissive sense (e.g., meaning having the potential to), rather than the mandatory sense (e.g., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, e.g., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing actions A, B, C, and D) encompasses both all such attributes or functions being mapped to all such objects and subsets of the attributes or functions being mapped to subsets of the attributes or functions (e.g., both all processors each performing actions A-D, and a case in which processor 1 performs action A, processor 2 performs action B and part of action C, and processor 3 performs part of action C and action D), unless otherwise indicated. Further, unless otherwise indicated, statements that one value or action is “based on” another condition or value encompass both instances in which the condition or value is the sole factor and instances in which the condition or value is one factor among a plurality of factors. The term “each” is not limited to “each and every” unless indicated otherwise. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In this patent filing, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

1. A tangible, non-transitory, machine-readable medium storing instructions that when executed by one or more processors effectuate operations comprising:
obtaining, by a computer system, a dataset
training, with the computer system, one or more machine learning models as an autoencoder to generate as output a reconstruction of the dataset based on an input of the dataset, wherein the autoencoder comprises deterministic layer and wherein training is based on minimization of reconstruction loss;
adding one or more stochastic noise layers to the trained one or more machine learning models of the autoencoder
adjusting, with the computer system, parameters of the stochastic noise layers according to an objective function that is differentiable; and
storing, with the computer system, the one or more machine learning models of the autoencoder with the stochastic noise layers in memory.
